(19) United States
(12) Patent Application Publication
(10) Pub. No.: US 2006/0053478 A1
(43) Pub. Date: Mar. 9, 2006

(54) System, method and computer program product for control of a service request

(75) Inventors: Randall William Horman, Toronto (CA); Mark Francis Wilding, Barrie (CA)

Correspondence Address: SUGHRUE MION PLLC;USPTO CUSTOMER NO WITH IBM/SVL, 2100 PENNSYLVANIA AVENUE, N.W., WASHINGTON, DC, 20037, US

(73) Assignee: International Business Machines Corporation, Armonk, NY (US)

(21) Appl. No.: 10/937,842

(22) Filed: Sep. 8, 2004

(51) Int. Cl. H04L 9/00; G06F 17/00; H04K 1/00

(52) U.S. Cl. 726/1; 713/153

(57) ABSTRACT

Disclosed is a data processing system, a data processing system implemented method and an article of manufacture for controlling, based on a policy, a service request containing an action to be executed on a product to be serviced. The data processing system includes a service module for receiving the service request, a policy manager for applying the policy to determine whether the service request is one of accepted and rejected, and a product interface for executing, on the product, the action contained in the accepted service request.

### FIELD OF INVENTION

The present invention relates to the field of remote product service. In particular, to a system, method and computer program product for controlling a service request.

### BACKGROUND

An approach commonly used by service organizations (a.k.a. service providers) to service software and hardware products at customer locations is through the use of remote service sessions. A remote service session typically includes a network connection between the product to be serviced and a service platform used by the service provider. Interaction between the service platform and the product to be serviced takes the form of requests for actions to be executed on the product.

There are a number of challenges involved with remotely servicing a software or hardware product. These can include: the lack of automated data transfer back to the service organization; lack of a secure remote connection; lack of control over the remote connection; inability for the customer or the product to establish an interactive service session; susceptibility to session hi-jacking; inability to create permanent, periodical or temporary service sessions; inability to enforce time limits for sessions; inability for a customer to watch or monitor the remote session; lack of ability to increase or reduce the level of interaction; lack of ability for customers to electronically communicate in real time with the service provider; and the lack of ability to apply similar control and monitoring over automated service sessions.

What is needed is a system and method for overcoming the above mentioned limitations of remote product service.

### SUMMARY OF INVENTION

In accordance with one aspect of the present invention, there is provided a data processing system for controlling, based on a policy, a service request containing an action to be executed on a product to be serviced, the data processing system including a service module for receiving the service request, a policy manager for applying the policy to determine whether the service request is one of accepted and rejected, and a product interface for executing, on the product, the action contained in the accepted service request.

In accordance with another aspect of the present invention, there is provided a data processing system implemented method for controlling, based on a policy, a service request containing an action to be executed on a product to be serviced, the data processing implemented method including receiving the service request, applying the policy to determine whether the service request is one of accepted and rejected, and executing, on the product, the action contained in the accepted service request.

In accordance with still another aspect of the present invention, there is provided a article of manufacture for controlling, based on a policy, a service request containing an action to be executed on a product to be serviced, the article of manufacture including data processing system usable medium tangibly embodying data processing executable code, the data processing executable code including data processing executable code receiving the service request, data processing executable code applying the policy to determine whether the service request is one of accepted and rejected, and data processing executable code executing, on the product, the action contained in the accepted service request.

Other aspects and features of the present invention will become apparent to those ordinarily skilled in the art to which it pertains upon review of the following description of specific embodiments of the invention in conjunction with the accompanying figures.

### BRIEF DESCRIPTION OF DRAWINGS

The present invention will be described in conjunction with the drawings in which:

FIG. 1 is a schematic representation of an exemplary environment in which a service system according to the present invention can be used.

FIG. 2 is a schematic representation of an exemplary embodiment of a service system according to the present invention.

FIG. 3 is flow diagram representing the steps of an exemplary embodiment of a method according to the present invention.

FIG. 4 is flow diagram representing exemplary sub-steps of a portion of the method according to FIG. 3.

### DETAILED DESCRIPTION OF THE EMBODIMENTS

An embodiment provides a system, a method and a computer program product for control of a service request in a remote service session operated by a service provider for a product. The product can be, for example, at a customer's location. The product can be comprised of software, hardware or a combination thereof. The present invention comprises a service module that can access the product to be serviced and a service gateway connected to the service module and to a session end-point used by the service provider. The service module can be co-located with the product. The service gateway and session end-point can be co-located at the service organization's service delivery location. The present invention provides the customer control of a remote service session by providing the customer the ability to set policies to be applied by the service module to service requests received from the service gateway. Each policy is comprised of a set of rules. Each rule can approve or reject a service action request based on: the specific action requested, the scope of impact, the product component to be acted on, the time and date of interaction and combinations thereof.

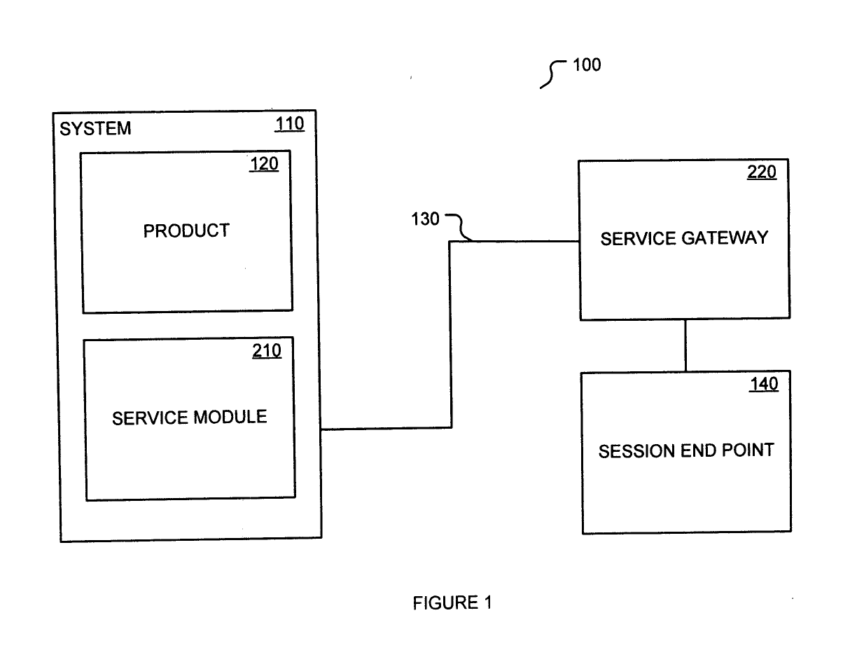

FIG. 1 is a schematic representation of an exemplary environment 100 in which a service system according to the present invention can be used. The environment 100 comprises a customer system 110 having a product 120 to be serviced and a service module 210 according to the present invention. The product can be comprised of software, hardware or a combination thereof such as, for example, an IBM DB2™ Universal Database. The service module 210 can access the product 120 for the purpose of executing service action requests. The service module 210 is connected, via a network connection 130, to a service gateway 220 according to the present invention. The service gateway 220 is connected to a session end-point 140. The session end-point can have a human interface or a machine interface used by the service provider for operation of a remote service session. The term service provider above and herein after includes a service provider agent, an automatic system and combinations thereof.

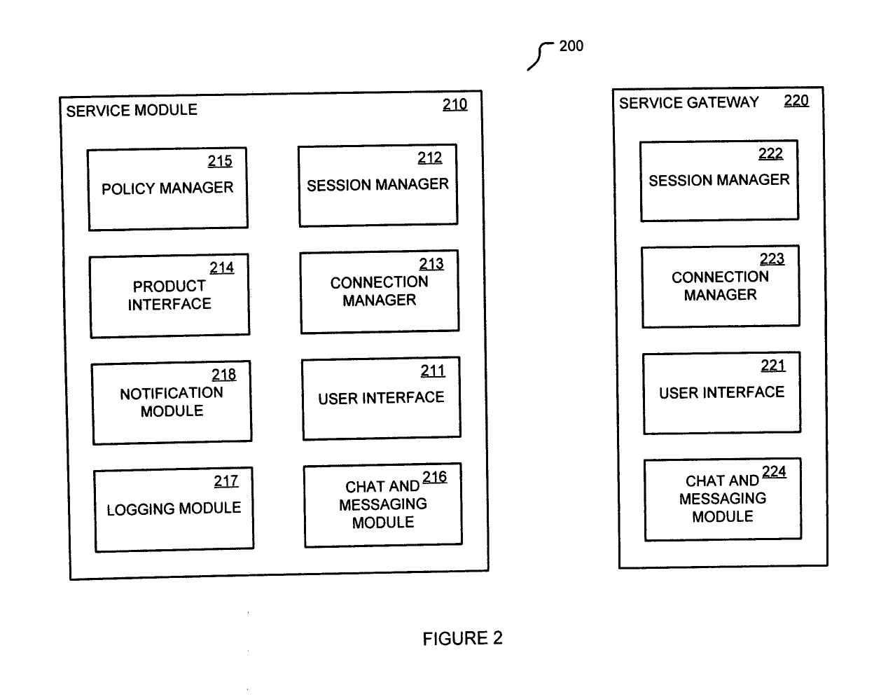

FIG. 2 is a schematic representation of a service system 200 according to the present invention. The service system comprises a service module 210 and a service gateway 220. The service module 210 comprises a user interface 211, a session manager 212, a connection manager 213, a product interface 214, a policy manager 215, a chat and messaging module 216, a logging module 217 and a notification module 218. The service gateway 220 comprises a user interface 221, a session manager 222, a connection manager 223 and a chat and messaging module 224.

Interactions between the serviced module 210 and the service gateway 220 occur in the context of a service session in which service action requests, information and messages are exchange. Session initiation and administration is provided for by the session managers 212, 222. The session can be commenced manually, for example, by the customer or it can be commenced by an automated process. The service session can be one that occurs periodically on a scheduled basis or one that occurs in reaction to a specific event or fault in the product. A session may operate in an unattended or in an interactive mode. In interactive mode the customer participates in the session.

Communication in a service session between the service module 210 and the service gateway 220 is provided for by a network connection 130 (see FIG. 1). The connection managers 213, 223 provide for the establishment, management and termination of the network connection 130 between the service module 210 and the service gateway 220. The network connection 130 can be a commonly known form of machine-to-machine communications such as, for example, a TCP/IP connection via the public internet. Above and herein after, connection denotes the ability to exchange communications using either connection-oriented or connectionless protocols. Authentication, authorization and security services for the network connection 130 can be provided using commonly known mechanisms. Establishment of the network connection 130 can be manually or automatically initiated. For security considerations, the network connection 130 can be initiated by the service module 210 to the service gateway 220.

Once the network connection 130 has been established, service action requests can be sent from the service gateway 220 to the service module 210. A service action request can be initiated by a human operator (e.g. a service provider agent) or an automatic system connected to the service gateway 220 via the session end-point 140. The service action request is received at the service module 210.

The service action request is validated using policies administered by the policy manager 215. The policy manager 215 provides for creation, administrations, management and storage of policies. Policies can be created by the customer by interaction with the policy manager 215 via the user interface 211. The customer can subsequently edit or delete policies via the user interface 211. Individual policies can be general and apply to all service sessions or they can be specific to a service session involving a specific service provider or service provider agent. For service provider or service provider agent specific policies, the identity of the service provider or service provider agent can be established and authenticated by the session manager 212.

Each policy takes the form of a set of rules. Table 1 presents a set of rules according to an exemplary embodiment of a policy according to the present invention. Each rule comprises fields representing: result, action, object, qualifier and time/date. The result field can take on values such as APPROVE and DENY which signify that an action request that matches the other fields of the rule will be approved or rejected respectively. The result field can also take on the value INTERACTIVE signifying that approval or rejection of the action request is deferred to the customer. In addition the result field value can be augmented with NOTIFY to signify that a notification will be sent if the other fields of the rule are matched. The action field takes on values such as QUERY, ACTION, CMD and ALL which signify that the rule applies to an action request that is a data query, an action on a component identified by the object field, a product command and any action request respectively. The object field describes an object of the action specified in the action field. The object can be, for example, a product component, DATA or a specific product command. The qualifier field specifies a qualifier for the scope of action on the object such as, for example, the type of data or source of data. The time/date field specifies a time and/or date range in which the rule applies.

TABLE 1

| Result | Action | Object | Qualifier | Time/Date |
|---|---|---|---|---|
| APPROVE | QUERY | BPS | CONFIG | 08:00 am-01:00 pm |
| APPROVE | ACTION | LOGGER | CONFIG | — |
| APPROVE | QUERY | DATA | DB:SAMPLE | Jan. 17, 2003-Jan. 20, 2003 |
| DENY/NOTIFY | ALL | DATA | — | — |
| INTERACTIVE | CMD | “vmstat 10” | — | — |
| DENY | ALL | — | — | — |

The first rule in the exemplary embodiment shown in Table 1 will approve queries (information only) for the buffer pool services (BPS) configuration between 8 μm and 1 pm each day. The second rule will approve actions (changes) for the transaction logging (LOGGER) configuration. The third rule will approve data queries for a database known as ‘SAMPLE’ during a four day span from Jan. 17, 2003 to Jan. 20, 2003. The forth rule will deny (i.e. reject) all access to data (from the product) and notify the customer of any attempts to access the data. The fifth rule will ask the customer in an interactive session to approve or reject an action for a specific command known as “vmstat 10”. The sixth rule will deny every other action.

The logging module 217 provides for recording logs associated with requested actions. The log information can be inspected by the customer via the user interface 211. Log information can also be requested by a service action and be returned to the service gateway 220.

The notification module 218 provides for a notification to be sent to the customer based on an action request. The notification can be sent when an action request is approved or rejected. Also, the notification can be sent when a session is interactive or non-interactive. When a service action request is rejected according to a policy in an interactive session, notification can be sent to the customer and the customer can choose to allow or not allow the rejected action. The notification can take the form of a user interface 211 prompt, an e-mail message, a pager message and other similar forms of notification.

Product interface 214 provides for the interaction between the service module 210 and the product 120 required to carry-out a policy or customer approved service action request.

The chat and messaging modules 216, 224 provide for the customer to exchange messages with a service provider agent at the session end-point 140 connected to the service gateway 220.

User interface 211 provides for the customer to interact with the service module 210. Interactions can include, for example, creating and administering polices, initiating and administering a network connection, initiating and administering a service session, receiving and reviewing logs, sending and receiving messages, receiving notifications, approving of policy rejected service action requests and other similar interactions.

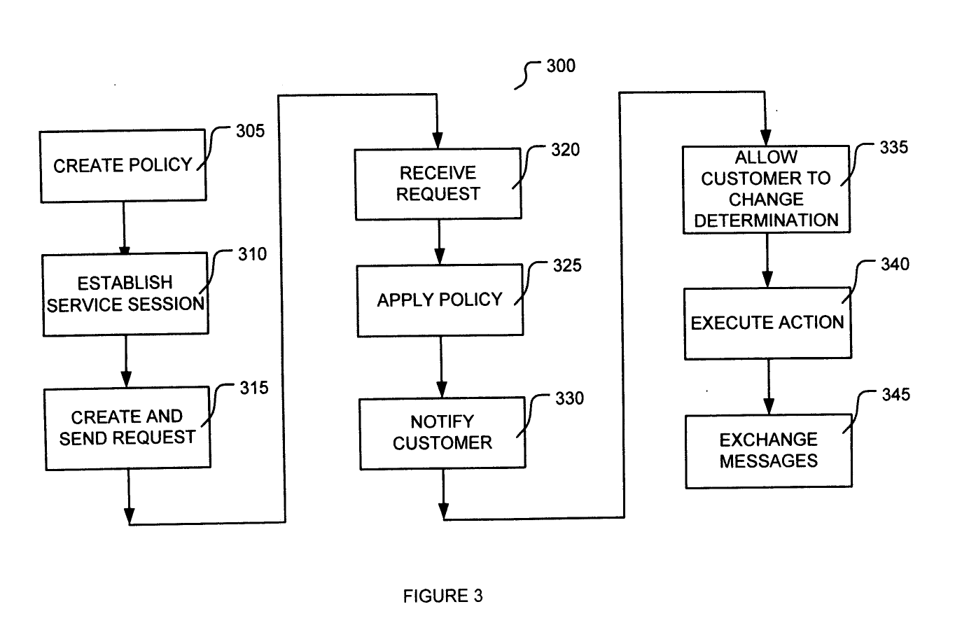

FIG. 3 represents a flow diagram of the steps of an exemplary embodiment of a method 300 according to the present invention. A policy is defined 305 by the customer interacting with the policy manager 215 via the user interface 211. The policy can, for example, take the form of a rule set as illustrated in Table 1. A service session is established and administered 310 by the session managers 212, 222. Administration of the service session can include establishing and administering of a network connection between the service module 210 and the service gateway 220 using connection managers 213, 223. Service session establishment and administration can also include functions such as, for example, authentication and authorization of participants in the session. A service request is created and send 315 based on interaction with the service provider agent via user interface 221. The service request is received 320 at the service module 210 from the service gateway 220. A rule set representing a policy is applied 325 to determine if an action containing in the service request is accepted or rejected. The customer can be optionally notified, via the notification module 218, of the result of the determination 330 when the service request is accepted, rejected or in either case. When the customer is notified that the service request is rejected, the customer can be allowed to change the determination 335 from rejected to accepted. When the service is accepted as a result of the policy determination or as a result of a change made by the customer, the action is executed 340 on the product via the product interface 214. At any time during the service session the customer and the service provider agent can exchanges messages 345 via the chat and messaging modules 216, 224 in order to dialog about the service request.

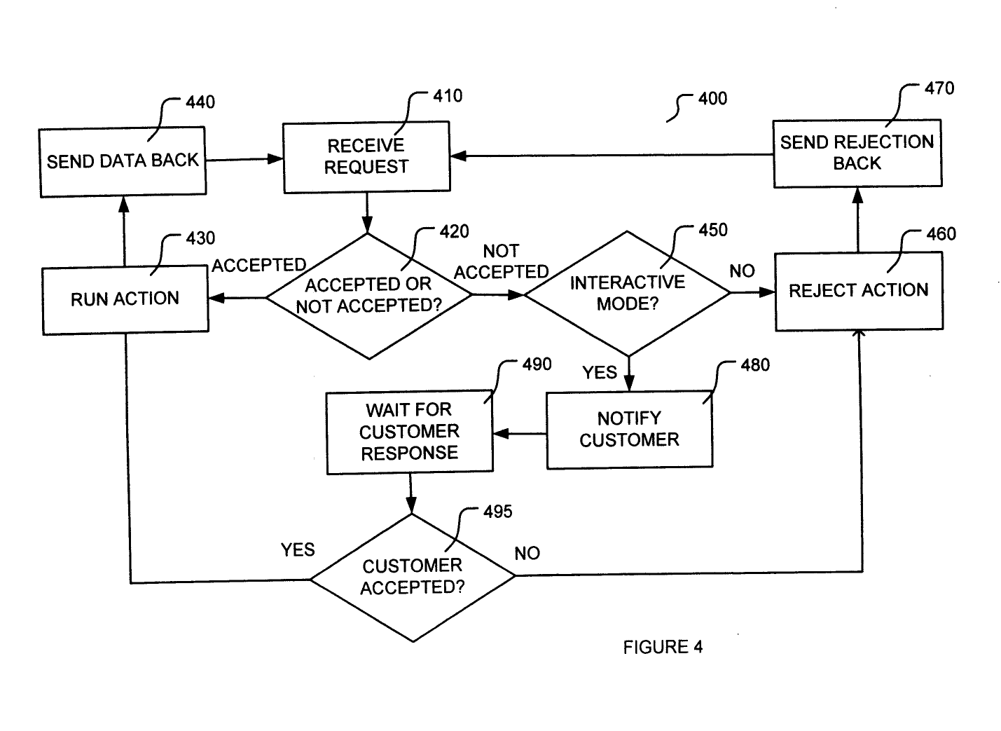

FIG. 4 represents a flow diagram of exemplary sub-steps of a portion 400 of the method 300 according to the present invention. The sub-steps of the portion 400 correspond to the steps 320, 325, 330, 335 and 340 of the method 300. An action request is received 410 at the service module 210 from the service gateway 220. A rule set representing a policy is applied 420. If the action request is accepted according to the policy, then the corresponding action is executed 430. After execution any resulting data is sent back 440 to the service gateway 220. If the action request is not accepted according to the policy, then handling of the action depends on the mode of the session 450. If the session is not interactive, then the action is rejected 460 and a rejection notification is sent back 470 to the service gateway 220. If the session is interactive, a notification is sent to the customer 480. The execution is suspended 490 waiting for the customer's response 495. If the customer accepts the action request, the action is run 430 and any resulting data is sent back 440 to the service gateway 220. If the customer does not accept, the action is rejected 460 and a rejection notification is sent back 470 to the service gateway 220.

An embodiment of the present invention can be implemented as a computer program product for execution on a computing platform.

It will be apparent to one skilled in the art that numerous modifications and departures from the specific embodiments described herein may be made without departing from the spirit and scope of the present invention.

1. A data processing system for controlling, based on a policy, a service request containing an action to be executed on a product to be serviced, the data processing system comprising:
a service module for receiving the service request;
a policy manager for applying the policy to determine whether the service request is one of accepted and rejected; and
a product interface for executing, on the product, the action contained in the accepted service request.

2. The data processing system of claim 1, wherein the policy comprising a plurality of rules each one specifying criteria used by the policy manager in determining the service request to be one of accepted and rejected.

3. The data processing system of claim 1, further comprising a service gateway for creating and sending the service request based on interaction with a service provider agent.

4. The data processing system of claim 1, further comprising a user interface for creating, in conjunction with the policy manager, the policy based on interaction with a customer associated with the product.

5. The data processing system of claim 3, further comprising a first and a second session manager, associated with the service module and the service gateway respectively, for establishing and administering a service session for the product in which the service request is sent and received.

6. The data processing system of claim 1, further comprising a notification module for notifying a customer associated with the product of the result of the determination of the service request to be one of accepted and rejected.

7. The data processing system of claim 6, the notification module further for allowing the customer to change the determination of the service request from rejected to accepted.

8. The data processing system of claim 3, further comprising a first and a second chat and messaging module for exchanging messages between a customer associated with the product and the service provider agent, respectively.

9. The data processing system of claim 1, further comprising a logging module for logging characterizations associated with the service request and the result of the determination of the service request to be one of accepted and rejected.

10. A data processing system implemented method for controlling, based on a policy, a service request containing an action to be executed on a product to be serviced, the data processing implemented method comprising:
receiving the service request;
applying the policy to determine whether the service request is one of accepted and rejected; and
executing, on the product, the action contained in the accepted service request.

11. The data processing system implemented method of claim 10, wherein the policy comprising a plurality of rules each one specifying criteria used in determining the service request to be one of accepted and rejected.

12. The data processing system implemented method of claim 10, further comprising creating and sending the service request based on interaction with a service provider agent.

13. The data processing system implemented method of claim 10, further comprising creating the policy based on interaction with a customer associated with the product.

14. The data processing system implemented method of claim 12, further comprising establishing and administering a service session for the product in which the service request is sent and received.

15. The data processing system implemented method of claim 10, further comprising notifying a customer associated with the product the result of the determination of the service request to be one of accepted and rejected.

16. The data processing system implemented method of claim 15, further comprising allowing the customer to change the determination of the service request from rejected to accepted.

17. The data processing system implemented method of claim 12, further comprising exchanging messages between a customer associated with the product and the service provider agent.

18. The data processing system implemented method of claim 10, further comprising logging characterizations associated with the service request and the result of the determination of the service request to be one of accepted and rejected.

19. An article of manufacture for controlling, based on a policy, a service request containing an action to be executed on a product to be serviced, the article of manufacture comprising:
data processing system usable medium tangibly embodying data processing executable code, the data processing executable code comprising:
data processing executable code receiving the service request;
data processing executable code applying the policy to determine whether the service request is one of accepted and rejected; and
data processing executable code executing, on the product, the action contained in the accepted service request.

20. The article of manufacture of claim 19, wherein the policy comprising a plurality of rules each one specifying criteria used in determining the service request to be one of accepted and rejected.

21. The article of manufacture of claim 19, further comprising data processing executable code for creating and sending the service request based on interaction with a service provider agent.

22. The article of manufacture of claim 19, further comprising data processing executable code for creating the policy based on interaction with a customer associated with the product.

23. The article of manufacture of claim 21, further data processing executable code for establishing and administering a service session for the product in which the service request is sent and received.

24. The article of manufacture of claim 19, further comprising data processing executable code for notifying a customer associated with the product the result of the determination of the service request to be one of accepted and rejected.

25. The article of manufacture of claim 24, further comprising data processing executable code for allowing the customer to change the determination of the service request from rejected to accepted.

26. The article of manufacture of claim 21, further comprising data processing executable code for exchanging messages between a customer associated with the product and the service provider agent.

27. The article of manufacture of claim 19, further comprising data processing executable code for logging characterizations associated with the service request and the result of the determination of the service request to be one of accepted and rejected.
